(19) United States
(12) Patent Application Publication
(10) Pub. No.: US 2026/0233478 A1
(43) Pub. Date: Aug. 13, 2026

(54) MOLD STRUCTURE FOR TIRES

(71) Applicant: HANKOOK TIRE & TECHNOLOGY CO., LTD., Gyeonggi-do (KR)

(72) Inventors: Jaiyoung CHO, Daejeon (KR); Jeonghee YOU, Daejeon (KR); Jeongheon KIM, Daejeon (KR); Haneol LEE, Daejeon (KR); Deokyeon SON, Daejeon (KR); Heesang CHUNG, Daejeon (KR)

(73) Assignee: HANKOOK TIRE & TECHNOLOGY CO., LTD., Gyeonggi-do (KR)

(21) Appl. No.: 19/531,431

(22) Filed: Feb. 5, 2026

(30) Foreign Application Priority Data
Feb. 7, 2025 (KR) 10-2025-0015558
Apr. 24, 2025 (KR) 10-2025-0054038
May 15, 2025 (KR) 10-2025-0063057

(51) Int. Cl. B29D 30/06; B29C 33/38; B29C 64/153; B33Y 10/00; B33Y 80/00

(52) U.S. Cl. CPC B29D 30/0606; B29C 33/3842; B29C 64/153; B29D 2030/0616; B29D 2030/0617; B33Y 10/00; B33Y 80/00

(57) ABSTRACT

A tire mold structure is disclosed. The disclosed tire mold structure may include a tread mold configured to receive a green tire before vulcanization and to form kerf recessed in the green tire during vulcanization, and a fixing jig in which the tread mold is fixed on an inner side thereof.

According to the disclosed tire mold structure, the tread mold is integrally manufactured to include a 3D kerf, a lateral groove, and a semi groove, thereby preventing deformation, detachment, and breakage of the 3D kerf that occur in conventional tire mold structures in which the 3D kerf are formed as separate structures.

### CROSS-REFERENCE TO RELATED APPLICATION

This application claims the benefit of Korean Patent Application Nos. 10-2025-0015558, filed on Feb. 7, 2025, 10-2025-0054038, filed on Apr. 24, 2025 and 10-2025-0063057, filed on May 15, 2025 in the Korean Intellectual Property Office, the disclosures of which are incorporated herein by reference.

### TECHNICAL FIELD

The present invention relates to a tire mold structure, and more particularly, to a tire mold structure capable of improving precision and durability of three-dimensional kerf, forming a pattern mold by additive manufacturing technology to engrave complex patterns on a tire, and minimizing thermal expansion during vulcanization.

### BACKGROUND

Conventional molds used for manufacturing tires having complex tread patterns, such as all-season tires or winter tires, have been manufactured by inserting separately fabricated three-dimensional kerf (hereinafter referred to as “3D kerf, Three-Dimensional kerf”).

The 3D kerf have tended to become thinner and more complex to improve tire performance, and designs that are difficult to realize using traditional manufacturing methods have been proposed.

Accordingly, the number of cases in which 3D kerf are manufactured using metal 3D printing technology has increased exponentially, and high-strength high-alloy steel materials have been widely used so as to withstand loads applied when separating a cured tire from a mold after vulcanization.

However, when the separately manufactured 3D kerf are inserted into a tire mold according to a tread pattern, an increase in the number of tire mold manufacturing processes is inevitable. In addition, since the material of the 3D kerf differs from that of the mold, deformation frequently occurs during the mold manufacturing process, resulting in reduced durability.

Conventional tire molds are mainly made of aluminum alloys and manufactured by casting. The 3D kerf made of high-alloy steel are inserted into a mold serving as an insert during casting and must withstand shrinkage stress inevitably generated during solidification of the aluminum alloy casting.

Such shrinkage stress remains even after the aluminum alloy casting is solidified and continuously acts on the kerf, and for this reason, deformation, breakage, and dimensional defects of the kerf frequently occur during the tire mold manufacturing process.

Meanwhile, molds including 3D kerf are used in a vulcanization process for curing tires.

The inserted 3D kerf additionally receive repeated loads due to a difference in thermal expansion coefficient from the aluminum alloy mold during vulcanization, which eventually leads to fatigue fracture, causing the kerf to be easily damaged even under a low load.

In addition, since the fixing force of the 3D kerf inserted through an additional process is weak, a problem arises in that the kerf are detached when separating the cured tire from the mold after vulcanization.

Meanwhile, micro-patterns are formed on side surfaces and bottom surfaces of grooves in tire tread patterns to reduce noise generated by tires.

As described above, tire tread patterns are becoming increasingly complex, which requires highly advanced mold manufacturing technology and results in increased mold manufacturing processes and time.

The increased manufacturing processes make it difficult to maintain quality between processes, which eventually leads to deterioration of the quality of tire molds and further deterioration of tire quality.

### SUMMARY

An object of the present embodiment is to provide a tire mold structure capable of preventing deformation, breakage, and dimensional defects of 3D kerf(Three-Dimensional kerf) occurring during tire mold manufacturing and vulcanization processes by including a tread mold having an integrated kerf structure made of a single material, and a fixing jig for fixing the tread mold and pattern molds.

Another object of the present embodiment is to provide a micro sheet capable of forming pattern elements thinner and shallower than 3D kerf on a tire surface.

Another object of the present embodiment is to provide a method for manufacturing such a micro sheet.

According to one aspect of the present invention, a tire mold structure may include a tread mold configured to receive a green tire before vulcanization and to form kerf recessed in the green tire during vulcanization, and a fixing jig in which the tread mold is fixed on an inner side thereof and when the tread mold and the fixing jig are coupled, a stepped portion may be formed between the tread mold and the fixing jig.

According to one aspect of the present invention, the tread mold may have a thickness that increases from a central portion toward shoulder portions at both ends.

According to one aspect of the present invention, the tread mold may be manufactured by an additive manufacturing technique, and may be manufactured by selective laser melting during the additive manufacturing process.

According to one aspect of the present invention, the tread mold may be integrally manufactured to include a 3D kerf, a lateral groove, a semi groove, and a main groove configured to form kerf recessed in the green tire.

According to one aspect of the present invention, the tread mold may be made of at least one of an iron alloy, a nickel alloy, and an aluminum alloy.

According to one aspect of the present invention, the tread mold may have a wave-shaped cross-sectional shape in a direction parallel to a ground surface at a portion thereof.

According to one aspect of the present invention, the tire mold structure may further include a micro sheet disposed on an inner side of the tread mold and configured to form micro slits recessed in the green tire during vulcanization.

According to one aspect of the present invention, the micro sheet may include a plurality of reinforcing ribs provided on one surface thereof.

According to one aspect of the present invention, each of the plurality of reinforcing ribs may be in contact with one surface of the micro sheet.

According to one aspect of the present invention, the plurality of reinforcing ribs may have a height of 30% to 100% of a height of the micro sheet and a thickness equal to or less than a thickness of the micro sheet.

According to one aspect of the present invention, the tread mold may be composed of a combination of a plurality of pattern molds, and the fixing jig may have an overall ring shape, in which the plurality of pattern molds provided in 8 to 200 pieces are fixed on an inner side thereof.

According to one aspect of the present invention, each of the plurality of pattern molds may include a support structure.

According to one aspect of the present invention, each of the plurality of pattern molds may have the same thickness from a central portion to a side portion.

According to one aspect of the present invention, each of the plurality of pattern molds may include at least one air vent having a shape selected from a linear slit, a cylindrical shape, a rectangular shape, and a lattice shape.

According to one aspect of the present invention, materials forming the tread mold and the fixing jig may be different from each other, such that a thermal expansion coefficient of the tread mold differs from a thermal expansion coefficient of the fixing jig.

The tire mold structure according to the present embodiment fundamentally prevents deformation, detachment, and breakage of 3D kerf occurring in conventional tire molds in which 3D kerf are separately manufactured and inserted, by manufacturing a tread mold having an integrated kerf structure made of a single material.

The tire mold structure according to the present embodiment is manufactured from a high-toughness alloy steel, thereby providing higher durability and ease of maintenance compared to conventional aluminum alloy tire molds, and being advantageous for disposal due to its single-material configuration, resulting in economic benefits.

The tire mold structure according to the present embodiment includes a thin integrated tread mold and a fixing jig for fixing the tread mold, thereby simplifying installation compared to conventional separately manufactured 3D kerf and improving manufacturing efficiency.

The fixing jig can be continuously used even when the tread mold is replaced, thereby increasing economic efficiency and installation process efficiency.

A tire having micro slits formed by the micro sheet according to the present embodiment improves initial grip on wet and snowy road surfaces, thereby enhancing safety.

In this case, the micro sheet is formed using selective laser melting, which is one of additive manufacturing processes, thereby reducing process difficulty and labor while maintaining high yield and quality.

Specifically, according to the present embodiment, during formation of the micro sheet, a laser moves along an outer periphery of a cross-section of the micro sheet to cause double melting, thereby preventing defects that may occur in a fine manufacturing process of the micro sheet and improving rigidity of the micro sheet. Accordingly, a thin yet high-strength micro sheet can be manufactured.

According to the present embodiment, by applying a plurality of reinforcing ribs to the micro sheet, the micro sheet can withstand shear force applied by a recoater during a recoating process accompanied by selective laser melting, thereby improving dimensional precision and straightness of the micro sheet.

According to the tire mold structure of the present embodiment, damage caused by rubber flow during vulcanization and damage during demolding after vulcanization can be prevented, and rubber blocks can be finely molded by the reinforcing ribs.

The tire mold structure according to the present embodiment minimizes thermal expansion that may occur during vulcanization, thereby preventing separation between pattern molds.

The tire mold structure according to the present embodiment improves dimensional precision of tires.

The effects of the present invention are not limited to those described above and should be understood to include all effects derivable from configurations described in the detailed description or claims.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view illustrating an example of a tread mold according to one embodiment of the present invention.

FIG. 2 is a cross-sectional view illustrating an example of a tire mold structure according to one embodiment of the present invention.

FIG. 3 is a perspective view illustrating an example of a tire mold structure according to one embodiment of the present invention.

FIG. 4 is a perspective view illustrating an example of a tire mold structure including a micro sheet according to one embodiment of the present invention.

FIG. 5 is a perspective view illustrating an example of a micro sheet according to one embodiment of the present invention.

FIG. 6 is a cross-sectional view illustrating a laser movement path for manufacturing the micro sheet by selective laser melting, taken along line A-A′ of FIG. 5.

FIG. 7 is a cross-sectional view illustrating a laser movement path for manufacturing the micro sheet by selective laser melting, taken along line B-B′ of FIG. 5.

FIG. 8 is a cross-sectional view taken in one direction of the tread mold according to one embodiment of the present invention.

FIG. 9 is a cross-sectional view taken along line A-A′ of FIG. 8

### DETAILED DESCRIPTION

Hereinafter, embodiments of the present invention will be described in detail with reference to the accompanying drawings. The embodiments described below are provided to fully convey the spirit of the present invention to those having ordinary skill in the art to which the present invention pertains. The present invention is not limited to the embodiments described herein and may be embodied in other forms. The drawings omit illustration of parts unrelated to the description to clarify the invention, and sizes of components may be exaggerated for clarity.

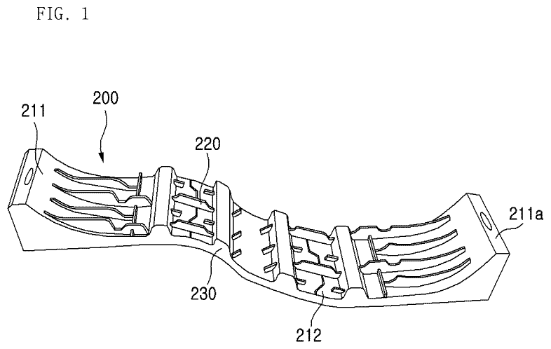

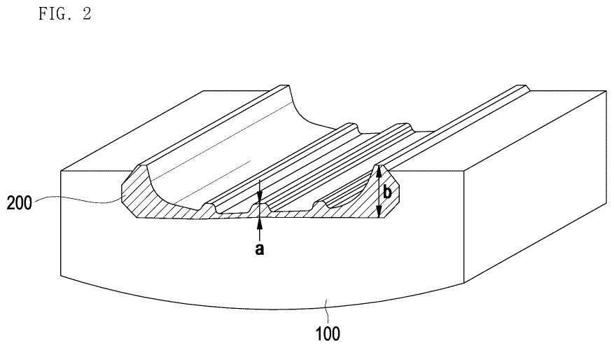

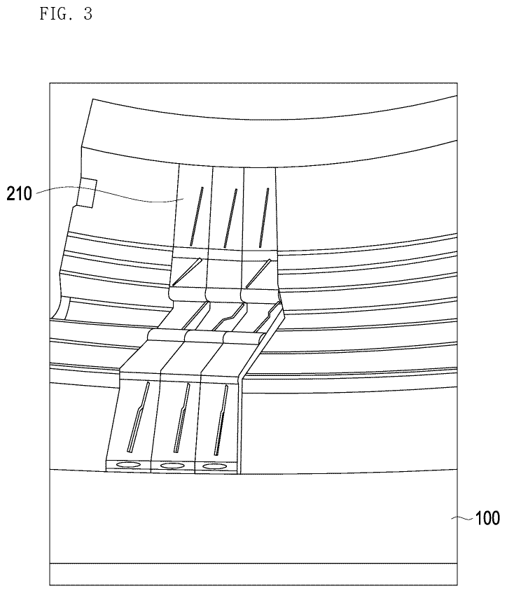

FIG. 1 is a perspective view illustrating an example of a tread mold according to one embodiment of the present invention, FIG. 2 is a cross-sectional view illustrating an example of a tire mold structure according to one embodiment of the present invention, and FIG. 3 is a perspective view illustrating an example of a tire mold structure according to one embodiment of the present invention.

A green tire refers to a tire that has been primarily processed to have an approximate shape of a tire through a forming process in manufacturing a pneumatic tire.

The processed green tire is placed in a vulcanization mold having a cavity corresponding to an outer shape of a finished tire together with various chemical agents, and then vulcanization and crosslinking reactions occur by heat and pressure, thereby forming a predetermined tread pattern and completing the tire with desired rubber properties.

At this time, a mold for forming a tread pattern of the finished tire, that is, various patterns related to drainage during rainy conditions and tire performance while contacting a road surface during driving, may be installed inside the vulcanization mold used in the vulcanization process for the green tire.

Referring to FIG. 1, the tire mold structure may include a tread mold 200 configured to receive a green tire before vulcanization and to form kerf recessed in the green tire during vulcanization.

Specifically, the tread mold 200 may be integrally manufactured to include a 3D kerf(Three-Dimensional kerf) 240, a lateral groove 220, a semi groove (not shown), and a main groove 230 configured to form kerf recessed in the green tire.

In addition, referring to FIG. 1, a portion of the tread mold 200 may have a wave-shaped cross-sectional shape in a direction parallel to a ground surface, in which a plurality of curved portions are connected.

Accordingly, a curved parting surface capable of maintaining a pitch shape formed in a single tread mold 200 may be designed.

Referring to FIGS. 2 and 3, the tire mold structure may include a fixing jig 100 in which the tread mold 200 is fixed on an inner side thereof.

### Meanwhile, the Tread Mold 200 May Be Manufactured by an Additive

manufacturing technique.

In order to enhance effectiveness of additive manufacturing and minimize deformation caused by residual stress, which is a disadvantage of additive manufacturing, the tread mold 200 may be manufactured with a minimum thickness.

For example, the thickness of the tread mold 200 may be formed to be minimum at a central portion of the tread mold 200.

The central portion of the tread mold 200 may be an O. D (Outside Diameter) portion that determines an outside diameter of the green tire.

In addition, the thickness of the tread mold 200 may increase from the central portion toward shoulder portions 211 at both ends, and may be maximum at the shoulder portions 211, but is not limited thereto.

According to the thickness variation from the central portion to the shoulder portions 211 of the tread mold 200, minute deformation that may occur during a manufacturing process can be compensated, and surface contact with the fixing jig can be induced by pressure of a bladder during vulcanization, thereby obtaining uniform vulcanization quality.

In this case, the thickness of the tread mold 200 may be 1.5 mm to 80 mm, and the thickness a of the central portion may be 1.5 mm to 15 mm.

For example, the thickness b of the shoulder portion 211 may be formed up to 80 mm.

In addition, the 3D kerf 240 may be formed with a thickness of 0.2 mm to 1 mm and may protrude in one direction, which is a direction in which kerf are recessed in the green tire.

Meanwhile, the tread mold 200 may be manufactured from at least one material selected from an iron alloy, a nickel alloy, and an aluminum alloy.

In conventional tire mold structures in which 3D kerf and molds are separately manufactured, due to low bonding strength between the 3D kerf and aluminum alloy molds, the 3D kerf may be separated from the aluminum alloy mold or damaged even under a load lower than a load that the 3D kerf can withstand.

In the tire mold structure according to the embodiment of the present invention, since the tread mold 200 is manufactured integrally with the 3D kerf 240, the conventional problem in which the 3D kerf 240 are separated from or damaged in the tread mold 200 under a low load can be solved.

In addition, since the tread mold 200 including the 3D kerf 240 is formed of a single material, uniform thermal expansion occurs during vulcanization, thereby ensuring consistent dimensional precision.

Further, referring to FIG. 3, the tire mold structure may further include pattern molds 210.

Specifically, the tread mold 200 may be composed of a combination of a plurality of pattern molds 210.

The fixing jig 100 may have an overall ring shape, and 8 to 200 pattern molds 210 may be fixed on an inner side thereof.

In this case, each pattern mold 210 may have the same thickness from a central portion to a side portion.

### Each Pattern Mold 210 May Include a Support Structure.

For example, during machining, the pattern mold (210) may be provided with a (solid) support (not shown) disposed around a periphery of the mold to support and reinforce the shape of the mold, thereby enabling rapid heat dissipation to minimize thermal deformation and firmly fixing the product so as to physically suppress deformation occurring during the process.

In this case, the support (240) may be installed along the periphery of the mold and formed to follow an outer contour of the mold, and reinforced portions may be additionally provided along major portions of the mold to improve durability of the support and prevent deformation of the mold under high pressure.

The support may be designed such that the mold operates stably under high temperature and high pressure, and for this purpose, the support may be made of a material having resistance to heat and pressure. During additive manufacturing, the support may be implemented by combining solid-type, cone-type, and block-type supports, thereby suppressing and minimizing deformation generated during the additive manufacturing process. In addition, deformation may be predicted using additive manufacturing analysis software, and a deformation-compensating design may be applied during manufacturing to improve precision.

Each pattern mold 210 may include an air vent having at least one shape selected from a linear slit, a cylindrical shape, a rectangular shape, and a lattice shape.

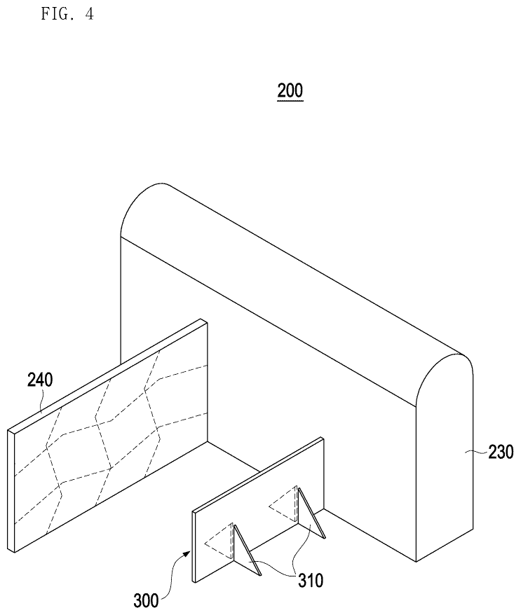

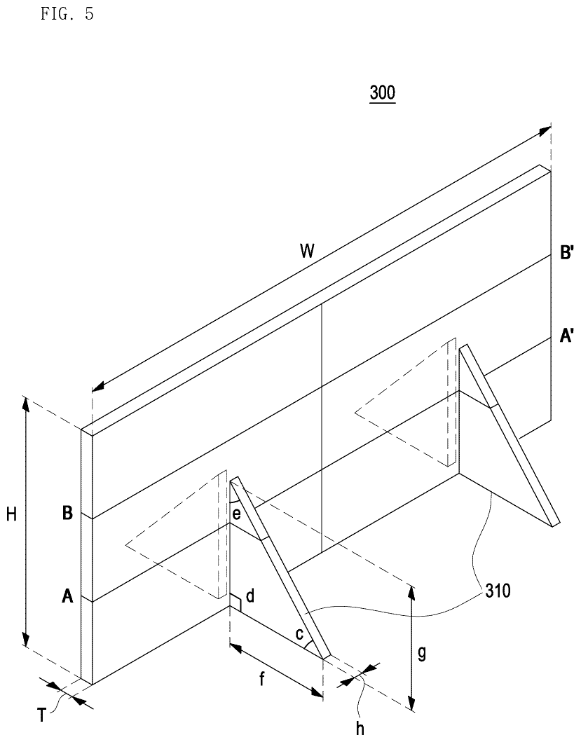

FIG. 4 is a perspective view illustrating an example of a tire mold structure including a micro sheet according to one embodiment of the present invention, and FIG. 5 is a perspective view illustrating an example of a micro sheet according to one embodiment of the present invention.

The tire mold structure of the present invention may include a micro sheet 300 disposed on an inner side 212 of the tread mold 200 and configured to form micro slits recessed in the green tire during vulcanization.

Referring to FIG. 4, the micro sheet 300 may be a tire tread pattern element lower and thinner than the 3D kerf 240 and a mold element for forming the pattern.

Referring to FIG. 5, the micro sheet 300 may have a height H of 2 mm or less, a thickness T of 0.2 mm or less, and a width W of 2 mm to 35 mm, and may be changed according to a shape of micro slits to be implemented on the tire, but is not limited thereto.

The micro sheet 300 may include a plurality of reinforcing ribs 310 provided on one surface or both surfaces thereof.

### The Reinforcing Ribs 310 May Increase Rigidity of the Micro Sheet 300.

The surface of the micro sheet 300 on which the reinforcing ribs 310 are formed may be a surface having the height H and the width W.

The plurality of reinforcing ribs 310 may be formed on the same surface or on both surfaces of the micro sheet 300.

### The Reinforcing Ribs 310 Located on Both Surfaces May Be Formed to Face

each other.

The reinforcing ribs 310 located on both surfaces may be formed at the same positions facing each other with the micro sheet 300 interposed therebetween, or may be formed at different positions with the micro sheet 300 interposed therebetween.

Each of the plurality of reinforcing ribs 310 may be formed in a right triangular prism structure.

Referring to FIG. 5, top and bottom surfaces of the triangular prism may be right triangles having the same shape.

The right triangle may include two acute angles a and c and one right angle d. Each of the two acute angles a and c may be in a range of 10° to 80°.

A surface of the triangular prism corresponding to one side including one acute angle c and the right angle d may be a bottom surface of the reinforcing rib 310.

The reinforcing rib 310 may be formed such that a side surface of the right triangular prism adjacent to one side including the right angle is in contact with one surface of the micro sheet 300. For example, a surface of the triangular prism corresponding to one side including one acute angle e and the right angle d may be a surface contacting the micro sheet 300.

Two sides forming a hypotenuse of the right triangle may correspond to a protruding length f of the reinforcing rib 310 from the micro sheet 300 and a height g of the reinforcing rib 310.

### The height g of the reinforcing rib 310 may be 30% to 100% of the height of the micro sheet 300.

The plurality of reinforcing ribs 310 may have different or identical heights g.

A height of the triangular prism may correspond to a thickness h of the reinforcing rib 310.

The thickness h of the reinforcing rib 310 may be equal to or less than the thickness T of the micro sheet 300.

The plurality of reinforcing ribs 310 may be spaced at equal or different intervals within the width W of the micro sheet 300 to maximize effects of the micro slits formed on the tire.

Meanwhile, the tire tread mold 200 of the present invention may be manufactured by selective laser melting during an additive manufacturing process using a laser spot diameter in a range of 0.06 mm to 0.12 mm.

According to selective laser melting, a laser moves along an outer periphery of a cross-section of the micro sheet 300 to cause double melting, thereby preventing defects that may occur in a fine manufacturing process of the micro sheet 300.

In addition, selective laser melting improves rigidity of the micro sheet 300, thereby enabling manufacturing of a thin yet high-strength micro sheet 300.

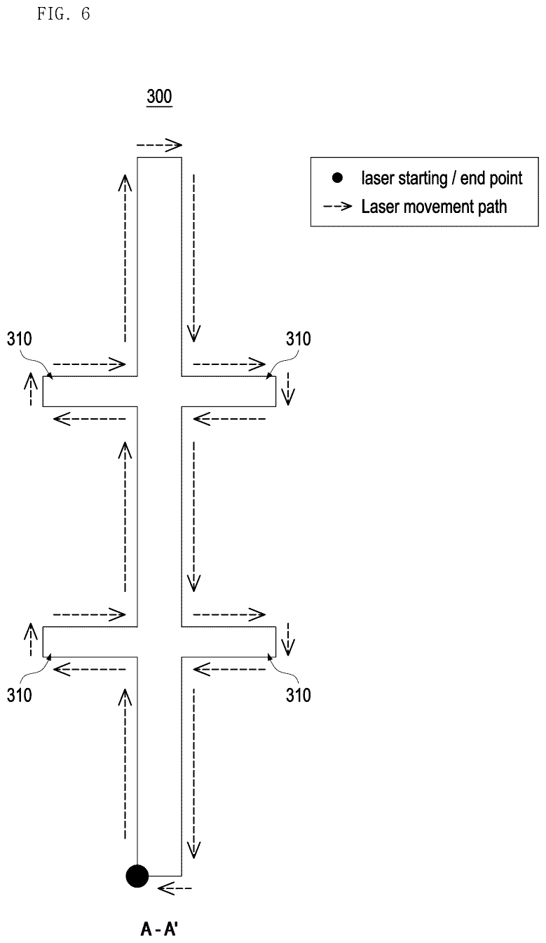

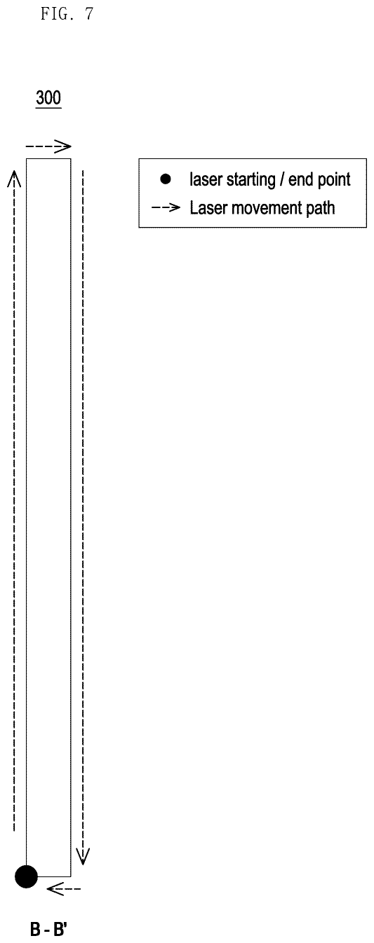

FIG. 6 is a cross-sectional view illustrating a laser movement path for manufacturing the micro sheet by selective laser melting, taken along line A-A′ of FIG. 5, and FIG. 7 is a cross-sectional view illustrating a laser movement path for manufacturing the micro sheet by selective laser melting, taken along line B-B′ of FIG. 5.

The micro sheet 300 may be manufactured by selective laser melting in a scanning direction corresponding to a perimeter of a cross-section including the plurality of reinforcing ribs 310.

Selective laser melting is performed by operation of a laser that locally melts regions along a perimeter of a desired shape on a bed surface filled with metal powder.

In this case, selective laser melting repeatedly performs a step in which the laser irradiates the bed surface and a step in which a recoater applies metal powder again (recoating step), thereby stacking desired shapes to output a three-dimensional structure.

Meanwhile, by adjusting an offset from model data of the micro sheet 300 including the plurality of reinforcing ribs 310, the thickness T of individual micro sheets 300 may be varied.

Referring to FIG. 6, the laser may irradiate while moving from a laser starting point along a path corresponding to the cross-section A-A′ of the micro sheet 300 including the plurality of reinforcing ribs 310 of FIG. 5, and return to an end point at the same position as the laser starting point, thereby forming a shape of the micro sheet 300 including the plurality of reinforcing ribs 310.

By forming the micro sheet 300 to include the plurality of reinforcing ribs 310, misalignment or breakage of the micro sheet 300 being formed due to movement of the recoater can be prevented. Accordingly, during formation of the micro sheet 300, stable additive forming can be achieved by reinforcement using the reinforcing ribs 310.

Referring to FIG. 7, the laser may irradiate while moving from a laser starting point along a path corresponding to the cross-section B-B′ of the micro sheet 300 not including the plurality of reinforcing ribs 310 of FIG. 5, and return to an end point at the same position as the laser starting point, thereby forming a shape of the micro sheet 300 not including the plurality of reinforcing ribs 310.

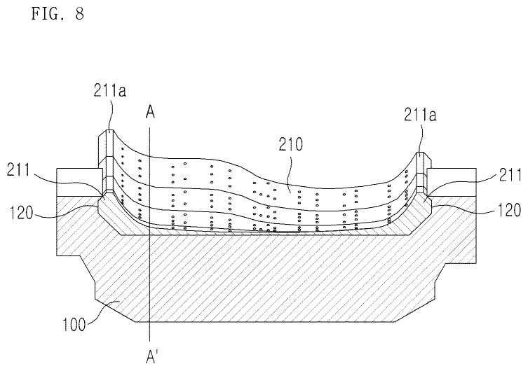

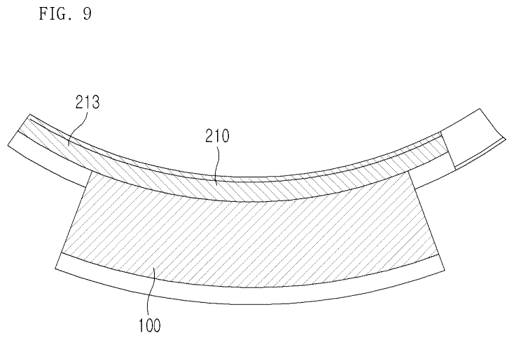

FIG. 8 is a cross-sectional view taken in one direction of the tread mold according to one embodiment of the present invention, and FIG. 9 is a cross-sectional view taken along line A-A′ of FIG. 8.

Referring to FIGS. 8 and 9, when materials of the fixing jig 100 and the tread mold 200 are different, thermal expansion coefficients of the respective materials may be different. A stepped portion 213 formed between the fixing jig 100 and the tread mold 200 may prevent shape deformation caused by thermal expansion of the fixing jig 100 and the tread mold 200.

Specifically, when the fixing jig 100 is formed of an aluminum alloy and the tread mold 200 is formed of high-strength steel, the fixing jig 100 has a greater thermal expansion coefficient. If the stepped portion 213 is not formed, a vertical length direction of the fixing jig 100 becomes greater than that of the tread mold 200 during heating, causing a step difference and resulting in deformation of the tire mold shape.

To prevent this, formation of the stepped portion 213 provides a space that prevents deformation of the tire mold shape due to a step difference between molds even when thermal expansion occurs.

The foregoing description of the present invention is provided for illustrative purposes, and those having ordinary skill in the art will understand that various modifications can be made without departing from the technical spirit or essential features of the present invention. Therefore, the embodiments described herein should be understood as illustrative and not limiting. For example, components described as being in a single form may be implemented in a distributed manner, and components described as being distributed may be implemented in a combined manner.

The scope of the present invention is defined by the claims described below, and all modifications or variations derived from the meaning, scope, and equivalent concept of the claims should be interpreted as being included in the scope of the present invention.

What is claimed is:

1. A tire mold structure comprising:
a tread mold configured to receive a green tire before vulcanization and to form kerf recessed in the green tire during vulcanization; and
a fixing jig having the tread mold fixed on an inner side thereof,
wherein, when the tread mold and the fixing jig are coupled, a stepped portion is formed between the tread mold and the fixing jig.

2. The tire mold structure according to claim 1,
wherein the tread mold has a thickness that increases from a central portion toward shoulder portions at both ends.

3. The tire mold structure according to claim 1,
wherein the tread mold is manufactured by an additive manufacturing technique, and
wherein the tread mold is manufactured by selective laser melting during the additive manufacturing process.

4. The tire mold structure according to claim 1,
wherein the tread mold is integrally manufactured to include:
a 3D kerf(Three-Dimensional kerf) configured to form kerf recessed in the green tire;
a lateral groove;
a semi groove; and
a main groove.

5. The tire mold structure according to claim 4,
wherein the tread mold is manufactured from at least one material selected from the group consisting of an iron alloy, a nickel alloy, and an aluminum alloy.

6. The tire mold structure according to claim 4,
wherein the tread mold has a wave-shaped cross-sectional shape in a direction parallel to a ground surface at a portion thereof.

7. The tire mold structure according to claim 1,
further comprising a micro sheet disposed on an inner side of the tread mold and configured to form micro slits recessed in the green tire during vulcanization.

8. The tire mold structure according to claim 7,
wherein the micro sheet includes a plurality of reinforcing ribs provided on one surface of the micro sheet.

9. The tire mold structure according to claim 8,
wherein one surface of each of the plurality of reinforcing ribs is in contact with one surface of the micro sheet.

10. The tire mold structure according to claim 8,
wherein a height of each of the plurality of reinforcing ribs is 30% to 100% of a height of the micro sheet, and
wherein a thickness of each of the plurality of reinforcing ribs is equal to or less than a thickness of the micro sheet.

11. The tire mold structure according to claim 1,
wherein the tread mold is composed of a combination of a plurality of pattern molds, and
wherein the fixing jig has an overall ring shape, and
wherein the plurality of pattern molds provided in 8 to 200 pieces are fixed on an inner side of the fixing jig.

12. The tire mold structure according to claim 11,
wherein each of the plurality of pattern molds includes:
a linear slit; and
an air vent having at least one shape selected from a cylindrical shape, a rectangular shape, and a lattice shape.

13. The tire mold structure according to claim 11,
wherein each of the plurality of pattern molds includes a support structure.

14. The tire mold structure according to claim 1,
wherein a material forming the tread mold and a material forming the fixing jig are different from each other, such that a thermal expansion coefficient of the tread mold differs from a thermal expansion coefficient of the fixing jig.
